(19) United States
(12) Patent Application Publication
(10) Pub. No.: US 2024/0026692 A1
(43) Pub. Date: Jan. 25, 2024

(54) DOOR FRAME SUPPORT ARRANGEMENT AND METHOD THEREFOR

(71) Applicant: LLEVITATE PTY LTD, Sydney, New South Wales (AU)

(72) Inventor: Dany George JABBOUR, Guildford (AU)

(21) Appl. No.: 17/629,753

(22) PCT Filed: Jul. 23, 2019
(86) PCT No.: PCT/AU2019/050769

§ 371 Date: Jan. 24, 2022

(51) Int. Cl. E04F 21/00

(52) U.S. Cl. CPC E04F 21/0015

(57) ABSTRACT

A door frame support arrangement (100) is provided in accordance with the invention. The door frame support arrangement (100) includes an engaging arrangement (200) configured for securely and releasably engaging a door frame (1000), preferably around the inner periphery (5) of the door frame, in use. The engaging arrangement (200) are preferably braced by bracing formations (300) to retain the door frame (1000) in a particular configuration (preferably as a rectangle) in use, and to resist movement of the door frame from that configuration. The door frame support arrangement (100) is installed on the door frame preferably before installation of the door frame to brace the door frame and ensure that it retains the correct configuration (0) for fitting a door. When the door is ready to be installed, the door frame support arrangement is removed and preferably a standard sized door is installed.

### FIELD OF THE INVENTION

The present invention relates to a door frame support arrangement and in particular to a support arrangement for supporting a door frame during construction.

The invention has been developed primarily for use in/with a door frame and will be described hereinafter with reference to this application. However, it will be appreciated that the invention is not limited to this particular field of use.

### BACKGROUND OF THE INVENTION

Currently, when undertaking outfitting of constructions such as multilevel apartments or residential houses, the framing is initially constructed. Door frames are then inserted in line with the framing. The door frames stay in place while other work such as electrical installation, plumbing installation or the like is carried out. Once this is finished, the dry walling or plasterboard is attached to the framing, and aligned carefully with the door frames.

Only at this stage are the doors installed in the door frames. Doors are typically installed in the door frames as one of the last jobs to be carried out, as they are cosmetic item, and it is desirable for them not to be damaged or marked during construction. Further, a construction site typically has a continuous movement of the various trades people through the doorways, and it is preferable that the doorway not be obstructed during ongoing construction.

However, door frames are typically composed of thin pressed sheet metal, and may lose their shape or be inadvertently moved out of shape while work is being carried out during the time between when the door frames are installed and the doors are installed. Additionally and/or alternately, door frames may be installed out of square and/or not at right angles or not extending vertically due to them being damaged during transport, or due to poor installation technique. For this reason, when it is time for doors to be fitted, measurements are normally taken of the door frame, and the doors are shaped on site to ensure a good fit in the door frame.

Such fitment is time-consuming and requires specialised trade skills.

The present invention seeks to provide a door frame support arrangement, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention may be said to consist in a door frame support arrangement for supporting a door frame from being moved out of shape during construction, the door frame support arrangement comprising:
a. at least one or more engaging arrangement configured for securely engaging with at least part of a door frame in use;
b. wherein the engaging arrangements are braced to retain the door frame in a particular configuration.

In one embodiment, the particular configuration is rectangular.

In one embodiment, the door frame support arrangement includes at least one or more bracing formations configured for bracing the engaging arrangement to thereby resist movement of the door frame from its particular configuration.

In one embodiment, the engaging arrangement configured for securely engaging at least part of a door frame in use.

In one embodiment, the engaging arrangement is configured for releasably engaging at least part of a door frame in use.

In one embodiment, the engaging arrangement is configured for releasably engaging a door frame around its periphery in use.

In one embodiment, the engaging arrangement includes at least one or more engaging members.

In one embodiment, the at least one or more engaging members are releasably connectable to each other.

In one embodiment, the at least one or more engaging members are connected to each other to present at least one or more engaging frames.

In one embodiment, each of the engaging frames includes at least a pair of telescoping members.

In one embodiment, the engaging arrangement include a pair of engaging frames.

In one embodiment, the engaging frames are configured for abutment with the door frame about a substantial portion of a periphery of the door frame in use.

In one embodiment, the engaging frames are configured for abutment with the door frame about a substantial portion of an inner periphery of the door frame in use.

In one embodiment, each of the engaging frames includes at least one or more L-shaped members.

In one embodiment, the L-shaped members include a pair of legs extending at substantially right angles to each other.

In one embodiment, each of the engaging frames includes at least one or more braced L-shaped members.

In one embodiment, each of the engaging frames includes two pairs of L-shaped members.

In one embodiment, one of the two pairs of L-shaped members is configured for telescoping engagement with the other of the two pairs of L-shaped members.

In one embodiment, the L-shaped members are configured for telescopic engagement with each other in an endless formation.

In one embodiment, the engaging arrangement includes at least one or more adjustment mechanism for facilitating the adjustment of the size and/or shape of the engaging arrangement.

In one embodiment, the adjustment mechanism includes at least one or more threaded fastener.

In one embodiment, the at least one or more threaded fastener is receivable into a complementary threaded aperture in an engaging frame.

In one embodiment, the engaging arrangement is conveniently disassembleable for facilitating transport and/or storage.

In one embodiment, the engaging arrangement or parts thereof are nestable with similar engaging arrangements or parts thereof.

In one embodiment, the engaging arrangement includes a clamping arrangement.

In one embodiment, the clamping arrangement is configured for clamping the engaging arrangement on opposed surfaces of the door frame in use.

In one embodiment, the clamping arrangement includes a tensioning mechanism.

In one embodiment, the tensioning mechanism is configured for pulling the pair of engaging frames towards each other to thereby clamp against opposed surfaces of the door frame in use.

In one embodiment, the engaging frames include size markings for facilitating the installation of the door frame support arrangement in the door frame at the correct dimensions.

In one embodiment, the engaging frames include bracing formations for bracing the engaging frames against movement.

In one embodiment, the bracing formations extend between the legs of the L-shaped members.

In one embodiment, the bracing formations are configured as right angle triangles.

In one embodiment, the L-shaped members are disengageable from each other.

In one embodiment, the L-shaped members are configured for convenient nesting with similar L-shaped members during transport and/or storage.

In one embodiment, the bracing formations are permanently connected to the engaging members.

In one embodiment, the bracing formations are permanently connected between adjacent legs of the L-shaped members.

In one embodiment, the bracing formations are removable.

In one embodiment, the engaging frames include supplementary connecting formation is for connecting supplementary bracing formations.

According to a further aspect, the present invention may be said to consist in a method of installation of a door, the method comprising the steps of:
a. installing a door frame support arrangement to support a door frame;
b. installing the supported door frame;
c. removing the door frame support arrangement from the door frame; and
d. installing a door in the door frame.

In one embodiment, the bracing is installed in a configuration that maintains a particular configuration.

In one embodiment, the door has a configuration corresponding to the maintained configuration of the door frame.

In one embodiment, the door has a configuration corresponding to the configuration that the door frame support arrangement is supporting the door frame in.

In one embodiment, the step of installing the door frame support arrangement includes the step of installing the door frame support arrangement as described above.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 shows a top right perspective view of a door frame support arrangement;

FIG. 2 shows a close-up view of the middle portion of the door frame support arrangement of FIG. 1;

FIG. 3 shows a close-up view of a bottom portion of the door frame support arrangement of FIG. 1;

FIG. 4 shows a close-up view of a top portion of the door frame support arrangement of FIG. 1;

FIG. 5a shows a front view of the door frame support arrangement of FIG. 1;

FIG. 5b shows a side view of the door frame support arrangement of FIG. 1;

FIG. 6 shows a top front left perspective view of a first engaging frame;

FIG. 7a shows a front view of the engaging frame of FIG. 5;

FIG. 7b shows a right side view of the engaging frame of FIG. 5;

FIG. 8 shows a top perspective view of an inner L-shaped member with bracing formation;

FIG. 9 shows a top perspective view of an outer L-shaped member with bracing formation and adjustment mechanism;

FIG. 10 shows a close-up view of a tensioner attachment formation shown as circle A in FIG. 9;

FIG. 11 shows a close-up view of an adjustment mechanism in circle B in FIG. 5;

FIG. 12 shows a front view of an outer L-shaped member with bracing formation and adjustment mechanism;

FIG. 13 shows a cross-section cutaway view of detail B-B of FIG. 12;

FIG. 14 shows a cross-section cutaway view of a door frame support arrangement in use supporting a door frame mounted on a wall; and

FIG. 15 shows a close-up cutaway view of an inner L-shaped member showing measurement markings.

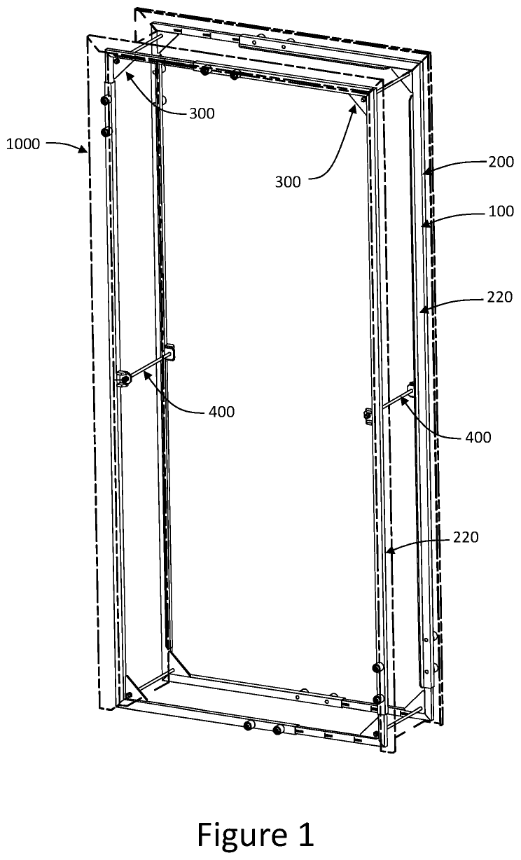

### DESCRIPTION OF EMBODIMENTS

It should be noted in the following description that like or the same reference numerals in different embodiments denote the same or similar features.

A door frame support arrangement according to a first aspect of the invention is generally indicated by the numeral 100. A door frame is generally indicated by the numeral 1000.

In one embodiment now described with reference to the figures, a door frame support arrangement or frame 100 is provided. The door frame support arrangement 100 includes an engaging arrangement 200 configured for securely and releasably engaging a door frame 1000, preferably around the inner periphery of the door frame, in use. The engaging arrangement 200 are preferably braced by bracing formations 300 to retain the door frame 1000 in a particular configuration (preferably as a rectangle) in use, and to resist movement of the door frame from that configuration.

The engaging arrangement 200 includes a plurality of engaging members in the form of L-shaped members 230, 240 that are releasably connectable to each other as a pair of preferably rectangular engaging frames 220. Each engaging frame 220 includes two pairs of inner L-shaped members 230 and outer L-shaped members 240.

When assembled and in use, the two pairs of L-shaped members 230, 240 form an endless configuration, preferably in the shape of a rectangle, that mirrors the configuration and size of the door frame 1000. In use, the engaging frames 220 will each securely engage in abutment with an opposed outer facing surface 1020 of the door frame 1000 on either side of the door frame. Preferably, the engaging frames 220 will engage with the door frame within a recess 1010 on each opposed side of the door frame 1000, although this is not necessary. The inner L-shaped members 230 and outer L-shaped members 240 are preferably made of a hollow steel or aluminium square tubing, although alternative materials that provide the necessary strength, stiffness and/or rigidity are envisaged. In use, it is envisaged that only the outer L-shaped members 240 will engage with the door frame 1000, although this need not necessarily be the case. For example, the inner L-shaped members can be provided with spacers (not shown) that are preferably the thickness of the walls of the outer L-shaped members 240, that allow for secure engagement with the door frame and/or the floor, providing additional stability and support to the door frame.

The inner L-shaped members 230 include a pair of legs 232 extending at substantially right angles to each other. Similarly, the outer L-shaped members 240 include a pair of legs 242 extending at substantially right angles to each other. Preferably, the outer L-shaped members 240 include a corner engaging flange 249 that is configured for facilitating the engagement of the outer L-shaped member on an outer corner of the door frame 1000. Where recesses are not available on opposed sides of the door frame, it is envisaged that an alternative outer L-shaped member may be provided that does not include a corner engaging flange.

It is envisaged that the engaging frames 220 on opposed sides of the door frame can mirror each other, but this need not necessarily be the case, and individual engaging frames can be provided on each side.

The legs 232 of the inner L-shaped members 230 are dimensioned to fit within the hollow interior of the legs 242 of the outer L-shaped members 240, in order to be telescopically engageable into and out of the legs 242. One leg 232 of an inner L-shaped member 230 will be telescopically engageable with the leg 242 of one adjacent outer L-shaped member 240, while the other leg 232 of the same L-shaped member 230 will be telescopically engageable with the leg 242 of the other adjacent outer L-shaped member 240.

In the embodiments shown, the door frame support arrangement 100 includes at least one or more bracing formations 300 configured for bracing the engaging arrangement to thereby resist movement of the door frame from its particular configuration. Preferably the bracing formations extend between the legs of the engaging arrangement 200 that engage adjacent portions of the door frame that extend at right angles to each other, as shown in the embodiments. However, it is also envisaged that in an alternative embodiment, the at least one or more bracing formations could alternatively or additionally extend between members of the engaging arrangement that engage with opposed parallel portions of the door frame located at opposed sides of the periphery of the door frame.

A bracing formation 300 in the form of a right-angled triangle plate 310 is preferably welded into the right-angled corner between the pair of legs 232 of the inner L-shaped members 230. Similarly, a bracing formation 300 in the form of a right-angled triangle plate 310 is preferably welded into the right-angled corner between the pair of legs 242 of the outer L-shaped members 240. These bracing formations 300 serve to brace the legs 232, 242 against movement out of perpendicular to each other. The bracing formations 300 shown in the figures also include apertures 312 so that the triangle plates 310 in each corner of the rectangular engaging frame 220 can serve as tensioner attachment formations 420 as will be described in more detail below.

In an alternative embodiment (not shown), it is envisaged that the bracing formations may be removable and need not be permanently secured in position. However, this is not preferable as this would require care in ensuring that the legs 232, 234 are properly aligned at right angles before installing the bracing formations.

In another alternative embodiment (not shown), it is envisaged that supplementary removable bracing formations may be provided to supplement the bracing provided by the permanent bracing formations. These may, for example, be in the form of a connector that extends between flanges on adjacent legs of the inner L-shaped members or outer L-shaped members. The connector can include hooks that may be hooked onto apertures and/or recesses in the flanges, or the connector can include threaded ends that are secured to the flanges by nuts. It is envisaged that such supplementary removable bracing formations may be useful where a particularly wide doorway is being supported by the frame support arrangement 100, in order to avoid bending of the longer sides of the rectangular engaging frames 220.

The engaging arrangement 200 is further provided with an adjustment mechanism 246 preferably associated with each leg 242 of the outer L-shaped members 240. The adjustment mechanisms 246 are all for facilitating the adjustment of the size and/or shape of the engaging arrangement 200.

The adjustment mechanism 246 includes threaded grub screw 247 that is receivable within a threaded bore or aperture 248 in a cylindrical tube 244 welded to the leg 242 of the outer L-shaped member. The aperture 248 extends through the leg 242, allowing the grub screw to engage with an outer surface of the leg 232 of an inner L-shaped member 230.

In the embodiments shown, the adjustment mechanism 246 is protected by a cylindrical shield 245. Turning the grub screw 247 into the threaded aperture to extend through the aperture to engage securely with an outer surface of a leg 232 of an inner L-shaped member 230 will hold the inner L-shaped member 230 and the outer L-shaped member 240 in secure engagement with each other, and prevent telescoping movement of the legs 232, 242. In this way the size and configuration of the engaging frames 220 can be reconfigured, and locked in position using the adjustment mechanism 246.

In an alternative embodiment (not shown), it is envisaged that the engaging frames need not be telescopically adjustable. Instead, it is envisaged that each engaging member could include a series of holes that can be aligned and a fastener, such as a bolt and nut arrangement, used to connect a pair of engaging members in a length just under the required length. An adjustment mechanism such as a threaded extension member that is longitudinally aligned with an engaging member can be screwed into or out of the engaging member to extend or shorten the length of the engaging member.

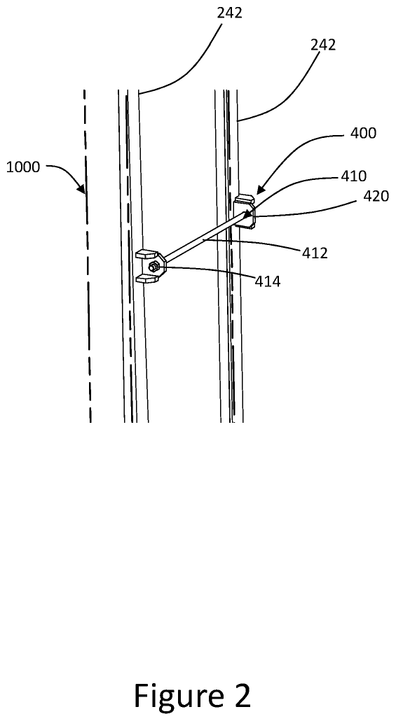

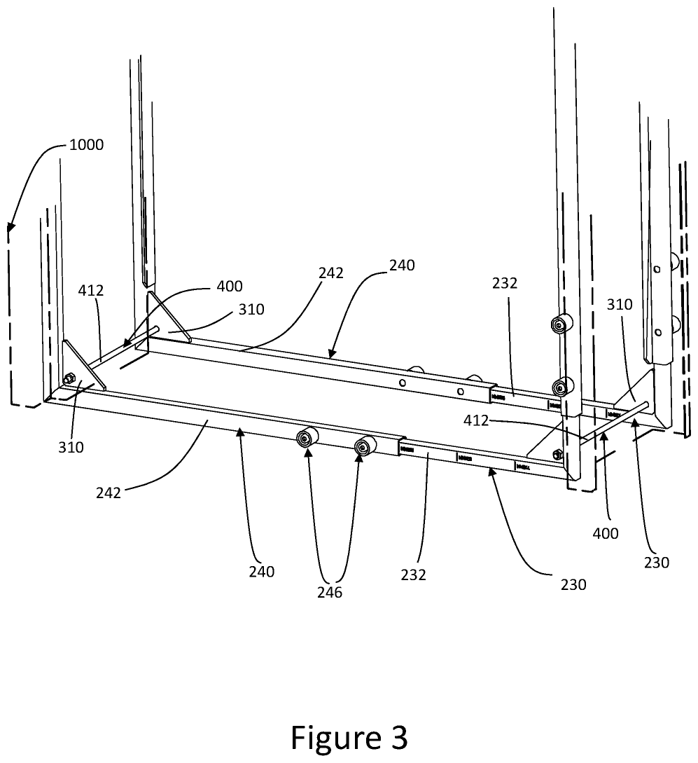

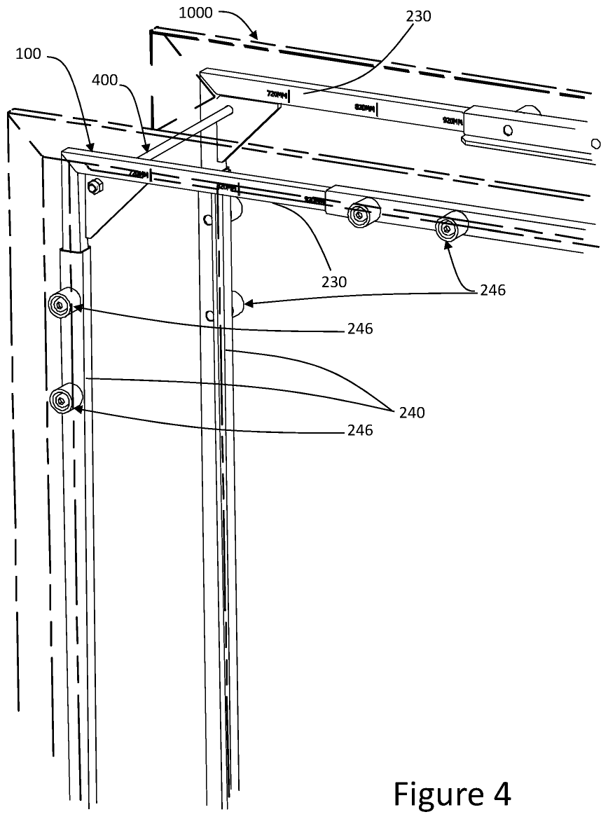

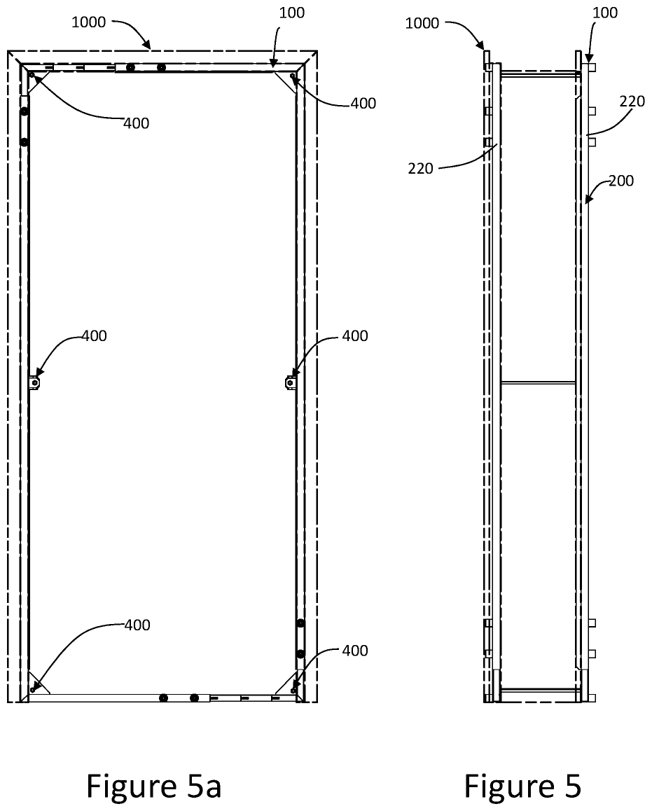

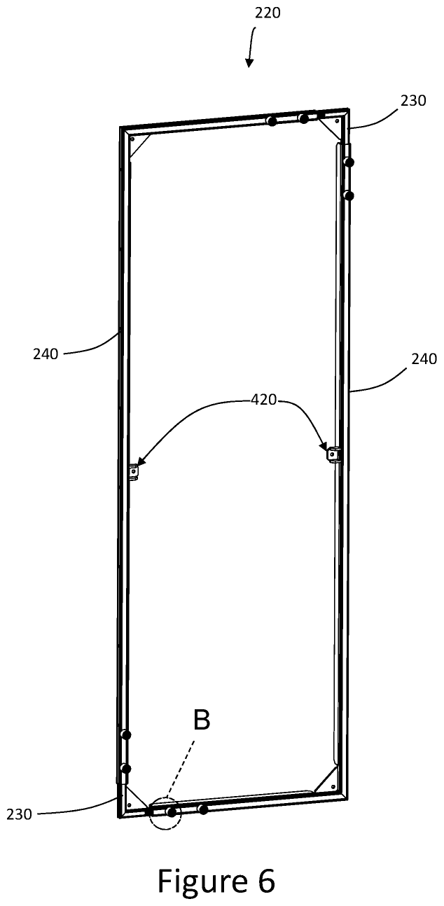

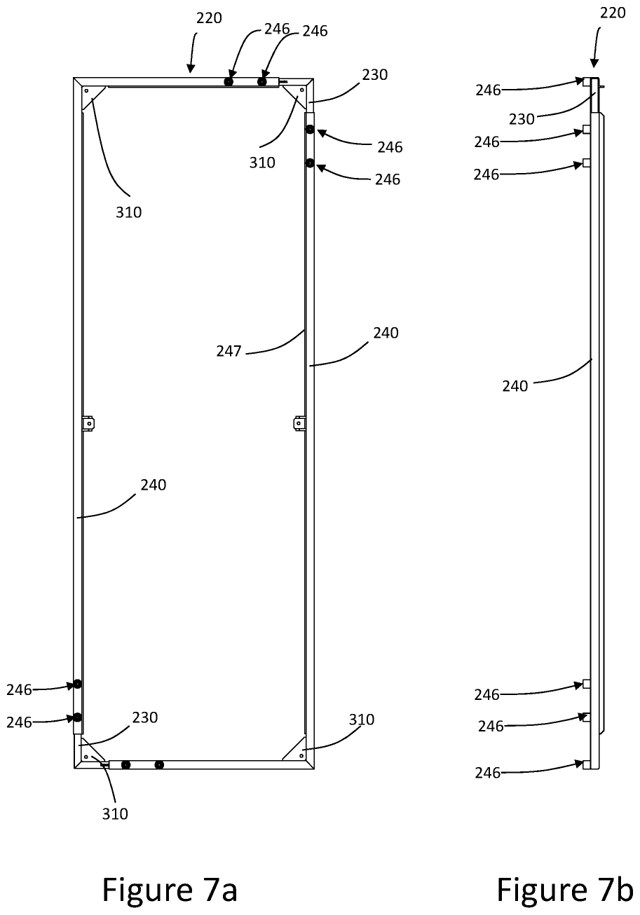

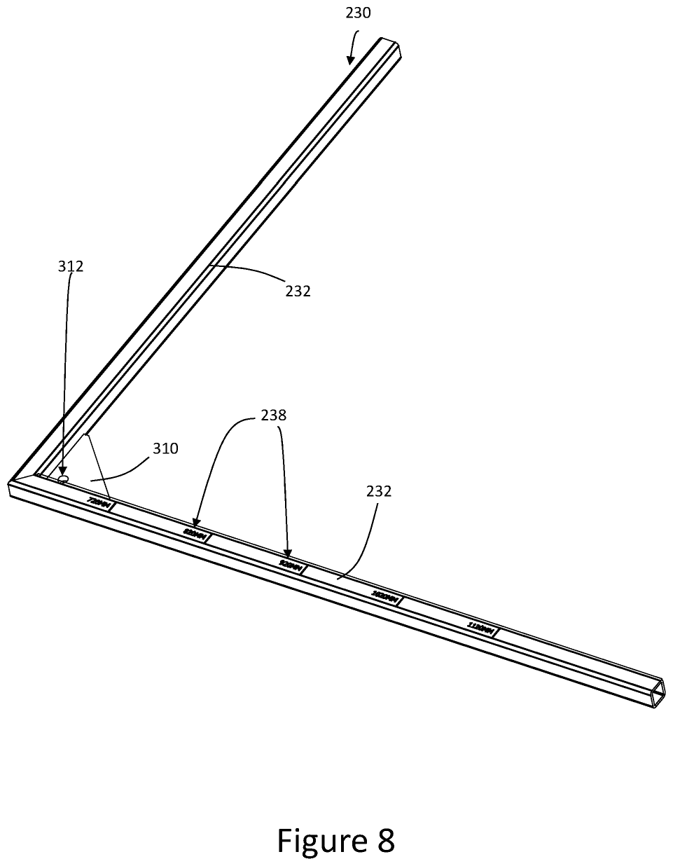

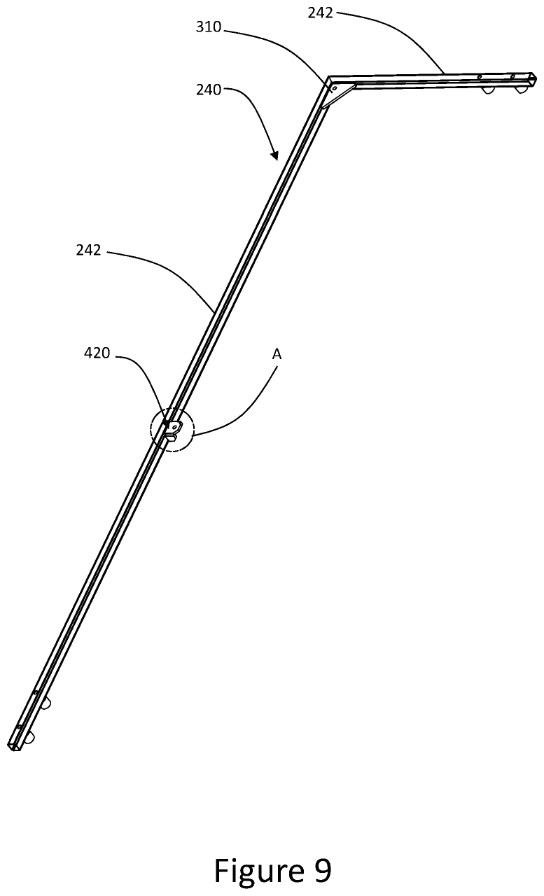

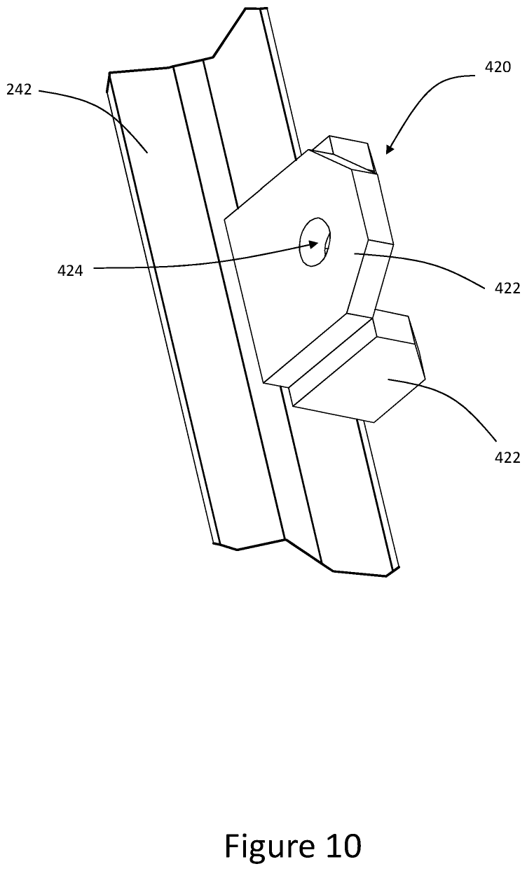

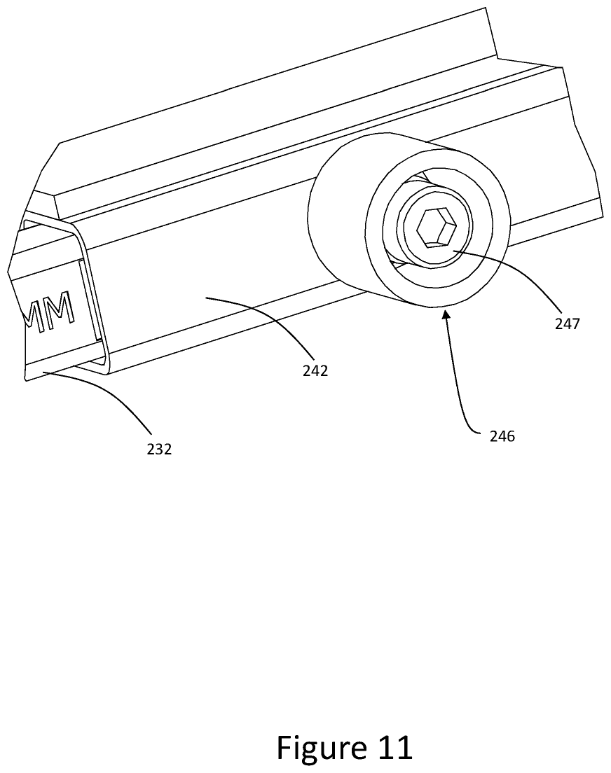

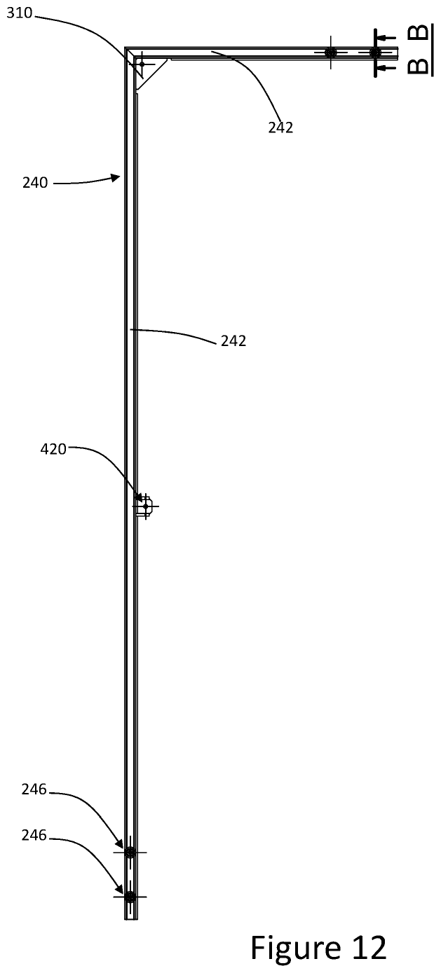

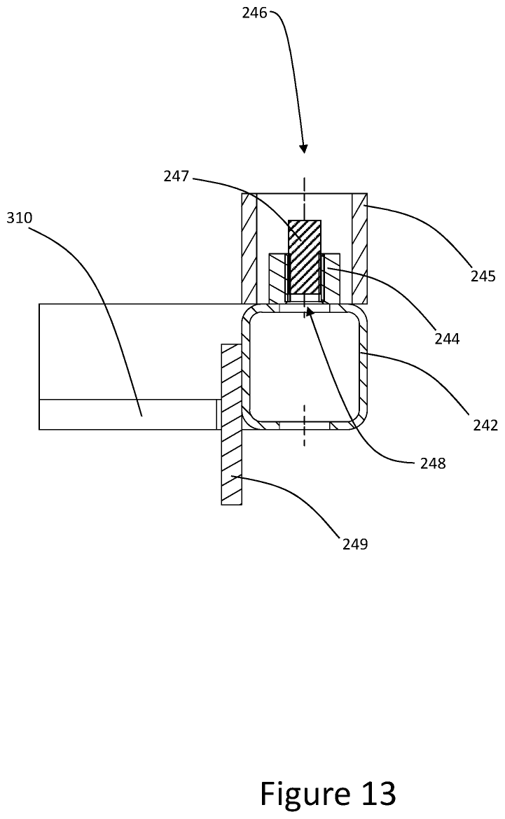

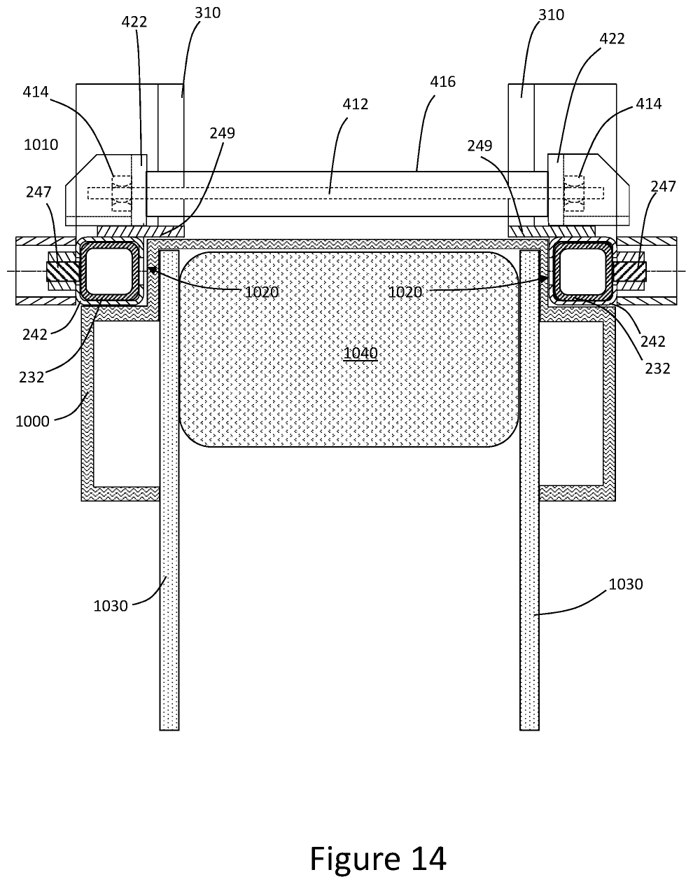

The frame support arrangement further includes a clamping arrangement 400 for securely clamping the engaging frames 220 onto opposed outer facing surfaces 1020 of the door frame 1000 in use. The clamping arrangement 400 includes a tensioning mechanism 410 in the form of a threaded shaft 412 that is securely engageable with tension attachment formations 420 including flanges 422 located on each of the rectangular engaging frames 220 by threaded nuts 414 (shown in FIGS. 2 and 14). As discussed above, the triangular plates 310 of the bracing formations 300 also include apertures 312 through which the threaded ends of the shafts 412 can be received, and secured to the triangular plates by nuts 440.

Threaded ends of the shaft 412 extend through apertures 424 in the flanges 422 in the attachment formations 420, and engage with nuts 414. Tightening of nuts 414 on the threaded ends of the shaft 412 pulls the rectangular engaging frames 220 located on opposed sides of the door frame 1000 towards each other, thereby clamping the door frame 1000 between them. In this way, the engaging arrangement is securely engaged with the door frame 1000.

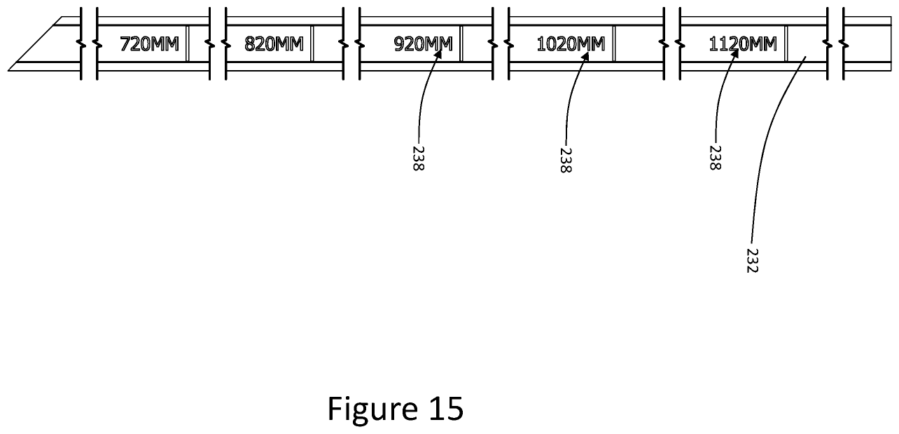

As shown in FIG. 15, preferably the legs 232 of the inner L-shaped members 230 include size markings 238. The size markings 238 can be stamped, painted, drawn, adhesively fixed to, or engraved into the L-shaped members 230. In this way, when the frame support arrangement 100 is being installed in a door frame 1000, the installer can set the size of the rectangular engaging frames 220 by aligning the size markings 238 with, for example, an end of a leg 242 of the outer L-shaped member, to ensure that a door (not shown) of a particular size will fit within the door frame 1000.

Preferably the markings may be in millimetres, but it is envisaged that they could be marked in inches, feet, or even in door sizes.

Preferably, the L-shaped members of each engaging frame 220 can be disengaged from each other or disassembled. It is envisaged that the L-shaped members 230, 240 can be conveniently nested for storage and transport.

FIG. 14 shows a cross-section of a pair of engaging frames 220 that are being clamped on a pair of opposed outer facing surfaces 1020 of a door frame 1000 by a tensioning mechanism 410. It should be noted that the flanges 422 of the tensioner attachment formations 420 preferably define an inner surface facing the opposed flange 422 that is in alignment with the outer facing surface 1020 of the door frame on the same side. It is envisaged that the tensioning mechanism 410 can include a spacer 416 through which the threaded shaft 412 extends. The spacer 416 preferably has a length corresponding to the distance between the opposed outer facing surfaces 1020 of the door frame 1000. When the nuts 412 are tightened, the spacer 416 prevents over tightening that may cause warping of the engaging frames 220 (and which could potentially move the engaging frames out of the intended configuration for the door to be installed).

### In Use

The door frame support arrangement 100 will preferably be attached to the door frame 1000. The door frames 1000 will then be installed in position on site with the door frame support arrangement 100 attached, thereby ensuring that the particular configuration (i.e. typically the rectangular configuration of the frame including right angles between corners) of the door frame is retained. The door frame support arrangement 100 also provides support to the door frame 1000 during transportation. The size and shape of the particular configuration will depend on the size and shape of the door (not shown) that is to be installed in the door frame.

In order to install the door frame support arrangement 100 on a door frame 1000, the L-shaped members 230, 240 will be telescopically engaged with each other to form engaging frames 220 in an endless configuration. When assembling the engaging frames 220, the applicable size markings 238 applicable to the intended size of the door that is to be installed may be used to assemble the engaging frames 220 with a correct sizing.

In alternative embodiments where the rectangular engaging frames are rigid and are not adjustable, these will simply be located in abutment to the opposed outer facing surfaces 1020 of the door frame.

The engaging frames 220 will be located in abutment with outer surfaces on opposed sides of the door frame 1000. The threaded shaft 412 of the tensioning mechanism will then be inserted through apertures 424 in the tensioner attachment formations 420, and nuts 414 screwed onto the ends of the threaded shaft 412 to full the engaging frames 220 together and thereby clamp the door frame 1000 between them. It is in envisaged that an appropriately sized spacer 416 can be fitted to the threaded shaft 412 during installation of the threaded shaft through the tensioner attachment formations 420 as shown in FIG. 14.

Similar threaded shaft is 412 will be inserted through apertures 312 in the triangular plates 310 of the bracing formations 300, and nuts screwed onto the end to ensure that the engaging frames 220 are being tensioned towards each other at preferably regular spacings along their periphery.

It is envisaged that a further part of the construction work will then be carried out, including installation of electricals and plumbing as may be required. While this work is being carried out, accessibility through the door frame 1000 is not restricted much, while the door frame 1000 is held or supported in that configuration, in order to prevent warping or movement from impacts or the like or human error during installation of the frame.

It is then envisaged that drywalling 1030 or other wall types will be installed onto the structural framing 1040, while being carefully sized to fit around the door frame 1000. Once the drywalling 1030 has been installed and finished, a door will be installed in the door frame. However, in contrast to the present construction process, the door will not need to be sized to make it fit a door frame that may have moved during the construction process. Instead, because the door frame support arrangement 100 has held the door frame 1000 in a correct configuration, a correctly sized door should be able to fit without the need for planing, cutting, sizing or the like.

It is envisaged that where alternative walling is used such as hebel or brickwalling, then once the cement or plaster has set, the door frame support arrangement can be removed without fear of further movement of the door frame.

In an alternative embodiment, (not shown) it is envisaged that the leg 232 that extends across the floor between the two opposed vertical stiles of the door frame could include a triangular formation or ramp that facilitates the movement of wheeled trolleys or wheelbarrows over the leg 232.

Rubber strips may be applied to the outer legs 242 on the face that engages with the door frame 1000, in order to prevent slippage and inadvertent movement of the door frame support arrangement 100 relative to the door frame.

It will be apparent to a person skilled in the art that a wide variety of alternative embodiments of the invention may be possible without departing from the scope of the invention. For example, in an alternative embodiment (not shown), it is envisaged that the engaging frames 220 can be rigid and need not necessarily be adjustable for different door frame sizes, nor able to be disassembled. In yet another embodiment (not shown), the engaging frames may be able to be disassembled, without being adjustable for various door frame sizes.

### Interpretation

### Markush Groups

In addition, where features or aspects of the invention are described in terms of Markush groups, those skilled in the art will recognise that the invention is also thereby described in terms of any individual member or subgroup of members of the Markush group.

### Chronological Sequence

For the purpose of this specification, where method steps are described in sequence, the sequence does not necessarily mean that the steps are to be carried out in chronological order in that sequence, unless there is no other logical manner of interpreting the sequence.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

For the purposes of this specification, the term “plastic” shall be construed to mean a general term for a wide range of synthetic or semisynthetic polymerization products, and generally consisting of a hydrocarbon-based polymer.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the construction industries.

1. A door frame support arrangement for supporting a door frame from being moved out of shape during construction, the door frame support arrangement comprising:
a) at least one or more engaging arrangement configured for securely engaging with opposed outer facing surfaces of at least part of a door frame in use;
b) wherein the engaging arrangement includes a clamping arrangement configured for securely clamping the engaging arrangement on opposed outer facing surfaces of the door frame in use, the clamping arrangement including a tensioning mechanism configured for pulling the pair of engaging frames towards each other to thereby clamp against opposed surfaces of the door frame in use; and
c) wherein the engaging arrangements are braced to retain the door frame in a particular configuration;
d) and wherein the door frame support arrangement allows access by users to walk through the door frame support arrangement when the door frame is supported in position on a construction site.

2. The door frame support arrangement as claimed in claim 1, wherein the door frame support arrangement includes at least one or more bracing formations configured for bracing the engaging arrangement to thereby resist movement of the door frame from its particular configuration.

3. The door frame support arrangement as claimed in claim 1, wherein the engaging arrangement includes at least one or more engaging members configured as an engaging frame.

4. The door frame support arrangement as claimed in claim 3, wherein the engaging frame is configured for abutment with the door frame about a substantial portion of a periphery of the door frame in use.

5. The door frame support arrangement as claimed in claim 3, wherein each of the engaging frames includes at least one or more pairs of telescoping members.

6. The door frame support arrangement as claimed in claim 1, wherein the engaging arrangement includes a pair of engaging frames configured for engagement with the door frame on opposed sides of the door frame in use.

7. The door frame support arrangement as claimed in claim 3, wherein each of the engaging frames includes at least one or more L-shaped members.

8. The door frame support arrangement as claimed in claim 7, wherein the L-shaped members include a pair of legs extending at substantially right angles to each other.

9. The door frame support arrangement as claimed in claim 7, wherein at least one or more of the L-shaped members are braced.

10. The door frame support arrangement as claimed in claim 3, wherein each of the engaging frames includes two pairs of L-shaped members.

11. The door frame support arrangement as claimed in claim 10, wherein one of the two pairs of L-shaped members is configured for telescoping engagement with the other of the two pairs of L-shaped members in an endless formation.

12. The door frame support arrangement as claimed in claim 1, wherein the engaging arrangement includes at least one or more adjustment mechanism configured for facilitating the adjustment of the size and/or shape of the engaging arrangement.

13. The door frame support arrangement as claimed in claim 12, wherein the adjustment mechanism includes at least one or more threaded fastener.

14. The door frame support arrangement as claimed in claim 13, wherein the at least one or more threaded fastener is receivable into a complementary threaded aperture in an engaging frame.

15. The door frame support arrangement as claimed in claim 1, wherein the engaging arrangement is configured to be conveniently disassembled for facilitating transport and/or storage.

16. The door frame support arrangement as claimed in claim 1, wherein the door frame includes at least one pair of adjacent frame portions, and the at least one or more bracing formation extends between at least two inside faces of adjacent frame portions of the door frame.

17. The door frame support arrangement as claimed in claim 1, wherein the door frame comprises at least one pair of opposing frame portions, and the at least one or more bracing formation extends between at least two inside faces of opposed frame portions of the door frame.

18. A method of installing a door, the method comprising the steps of:
a) installing a door frame support arrangement to support a door frame by clamping a an engaging frame on at least a pair of opposed sides of the door frame and tensioning a tensioning mechanism to thereby pull the pair of engaging frames towards each other to thereby clamp against opposed surfaces of the door frame in use;
b) installing the supported door frame;
c) allowing access by users through the door frame on site;
d) removing the door frame support arrangement from the door frame; and
e) installing a door in the door frame.

19. The method as claimed in claim 18, wherein the door has a configuration corresponding to the configuration that the door frame support arrangement is supporting the door frame in.

20. (canceled)

21. The method as claimed in claim 18,
wherein the engaging arrangement as claimed on a pair of opposed outer facing sides of the door frame.
